(19) United States
(12) Patent Application Publication
(10) Pub. No.: US 2021/0025470 A1
(43) Pub. Date: Jan. 28, 2021

(54) MONITORING SENSOR HAVING SAFETY FUNCTION FOR EVACUATING THE GAS PRESSURE SPRING WIRELESSLY

(71) Applicant: Fibro GmbH, Hassmersheim (DE)

(72) Inventor: Norbert REINMUTH, Hassmersheim (DE)

(21) Appl. No.: 16/967,289

(22) PCT Filed: Dec. 6, 2018
(86) PCT No.: PCT/EP2018/083845

§ 371 Date: Aug. 4, 2020

(30) Foreign Application Priority Data
Apr. 26, 2018 (DE) 10 2018 110 073.6

(51) Int. Cl. F16F 9/32; F16F 9/46

(52) U.S. Cl. CPC F16F 9/3292; F16F 9/466; G08C 17/02; F16F 2230/0047; F16F 2230/08; F16F 2230/24

(57) ABSTRACT

The invention relates to a monitoring sensor (1) for measuring, receiving and transmitting a physical variable (P) of a gas pressure spring (2), comprising a sensor element (3) and a pressure relief opening (4), characterized in that the pressure relief opening (4) can be switched from an operating state into a safety state by remotely triggering the sensor element (3) in order to evacuate the gas pressure spring (2), wherein the monitoring sensor (1) is designed with a connection device (5), which can be detached in accordance with the intended use, for connection to a coupling (6) of the gas pressure spring (2).

### CROSS-REFERENCE TO RELATED APPLICATIONS

This application is a National Stage of International Application No. PCT/EP2018/083845 filed Dec. 6, 2018, and published in German as WO 2019/206442 on Oct. 31, 2019. The application claims priority to German Application No. 10 2018 110 073.6, filed Apr. 26, 2018. The entire disclosures of the applications are incorporated herein by reference.

### FIELD AND BACKGROUND OF THE INVENTION

The present disclosure relates to a monitoring sensor, measuring, receiving and transmitting a physical variable of a gas pressure spring, including a sensor element and a pressure relief opening. The pressure relief opening can be switched from an operating state into a safety state. This occurs by remotely triggering the sensor element in order to evacuate the gas pressure spring. Furthermore, the monitoring sensor is designed with a connection device, that can be detached in accordance with the intended use, to connect with a coupling of the gas pressure spring.

Generic monitoring sensors are known from the prior art.

The occurrence of a crash situation in the tool requires that the gas pressure spring be evacuated before it can be removed safely. For this purpose, in the prior art, gas pressure springs are connected together. This is implemented either by hose lines or deep hole bores in a connection or support plate. With the aid of a draining device, the gas can be evacuated from the gas pressure spring from the outside via these components.

A disadvantage with this tool design is that, for evacuating the gas pressure spring, an additional component, the draining device, has to be used. In addition, a risk remains during the evacuation of the gas pressure spring since the tool user still has to work in the vicinity of the gas pressure spring. Furthermore, this tool design is very complex due to the additional components such as hose lines or the connection or support plate.

### SUMMARY

The aim of the present disclosure is to overcome the aforementioned disadvantages and to provide a draining device for a gas pressure spring. The draining device facilitates evacuation and in the process reduces the risk or accident risk and moreover the complexity of the tool design.

These aims are achieved by a monitoring sensor for measuring, receiving and transmitting a physical variable of a gas pressure spring, comprising a sensor element and a pressure relief opening. The pressure relief opening can be switched from an operating state into a safety state by remotely triggering the sensor element. This evacuates the gas pressure spring. The monitoring sensor is designed with a connection device. It can be detached in accordance with the intended use to connect to a coupling of the gas pressure spring.

According to the disclosure, a monitoring sensor for measuring, receiving and transmitting a physical variable of a gas pressure spring, comprising a sensor element and a pressure relief opening. The pressure relief opening can be switched from an operating state into a safety state by remotely triggering the sensor element in order to evacuate the gas pressure spring. The monitoring sensor includes a connection device, that can be triggered in accordance with the intended use, to connect with a coupling of the gas pressure spring. Here, it is advantageous that the remote triggering of the sensor element for evacuating the gas pressure spring enables a sufficiently large safety clearance from the gas pressure spring. Thus, the risk is minimized. In addition, a monitoring sensor can be mounted or removed at any time due to the connection device. This simplifies the maintenance of the draining device considerably. Furthermore, components such as hose lines or the connection or support plate are dispensed. This results in a considerable reduction of the complexity of the tool.

In an advantageous embodiment variant, the sensor element is designed to monitor a pressure in the gas pressure spring. Thus, the monitoring sensor can continuously measure the pressure within the gas pressure spring and transmit the measurement data.

Preferably, the monitoring sensor is designed so that, in addition to data for the pressure, the sensor element optionally determines one or all of the additional variables. They include the temperature, the part number, the part ID, the sensor ID, the position in the tool, the different cycle times, the battery status and the transmission power of the sensor. The sensor element transmits them wirelessly to a gateway or a data holder. Here, it is advantageous that all the operating data relevant to the operational safety of the gas pressure spring are determined. Furthermore, the additional data makes it possible to associate the operating data with a certain monitoring sensor, and, in an emergency, to rapidly locate the corresponding gas pressure spring. In addition, the maintenance is considerably simplified by this data.

In one embodiment, with reception of a certain signal or pressure, the monitoring sensor switches the pressure relief opening from the operating state into the safety state. The advantage of this feature is that the monitoring sensor performs the switching of the pressure relief opening into the safety state or into the operating state. Therefore, the user does not have to be in the immediate vicinity of the gas pressure spring. Thus, risk is considerably minimized. In addition, the use of an additional component for evacuating the gas pressure spring is eliminated.

Furthermore, in an advantageous embodiment, the adjustment of the pressure relief opening is triggered by the sensor element by an electromagnetic coil, a micro servo motor or an electromechanical adjustment unit. Here, it is advantageous that these components can be produced in appropriate size. Also, it is advantageous that sufficient force can be applied to switch the pressure relief opening, while using little energy in the process and implementing the energy provision in a simple manner.

In an advantageous application example of monitoring sensors according to the disclosure, the sensor includes a battery or a mechanically chargeable energy storage, that provide the energy for adjusting the pressure relief opening. In conventional tool operation, the battery lifespan is several years and replacement can be carried out simply during routine maintenance work.

In an embodiment variant, the monitoring sensor pressure relief opening is designed as a valve, in particular as a 2/2-way safety valve. The 2/2-way safety valve provides exactly two switch positions. One position for the operating state and one for the safety state. Thus, it is particularly suitable for the monitoring sensor according to the disclosure.

It is also advantageous if the signal for remote triggering of the sensor element is transmitted wirelessly or via Bluetooth.

The sensor element includes a housing made of plastic and a base plate made of aluminum. The mechanical construction of the sensor element is designed to be impact- and vibration-resistant in accordance with the operating conditions.

In the present monitoring sensor, it is provided that the sensor element has an operating temperature range from 0° C. to 80° C.

According to the disclosure, it is moreover advantageous that the sensor element has a temperature measurement range from 0° C. to 85° C. and a pressure measurement range from 0 bar to 500 bar.

In a preferred embodiment of the disclosure, the valve is integrated in the connection section between the connection device and the sensor element.

Other advantageous developments of the disclosure are characterized in the dependent claims and represented in further detail below along with the description of the preferred embodiment of the invention in reference to the figures.

### DRAWINGS

The drawings described herein are for illustrative purposes only of selected embodiments and not all possible implementations, and are not intended to limit the scope of the present disclosure.

FIG. 1 is a side elevation view of a gas pressure spring with a monitoring sensor; and

FIG. 2 is a schematic diagram of a gas pressure spring with a monitoring sensor.

### DETAILED DESCRIPTION

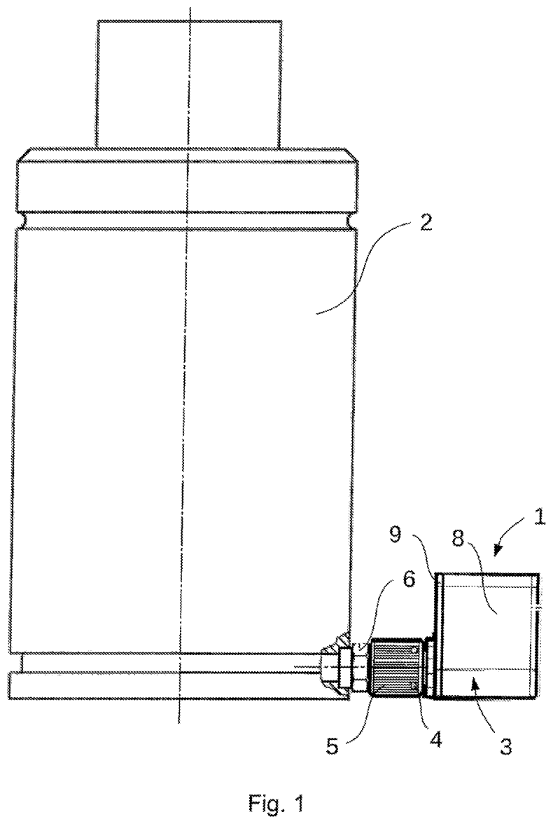

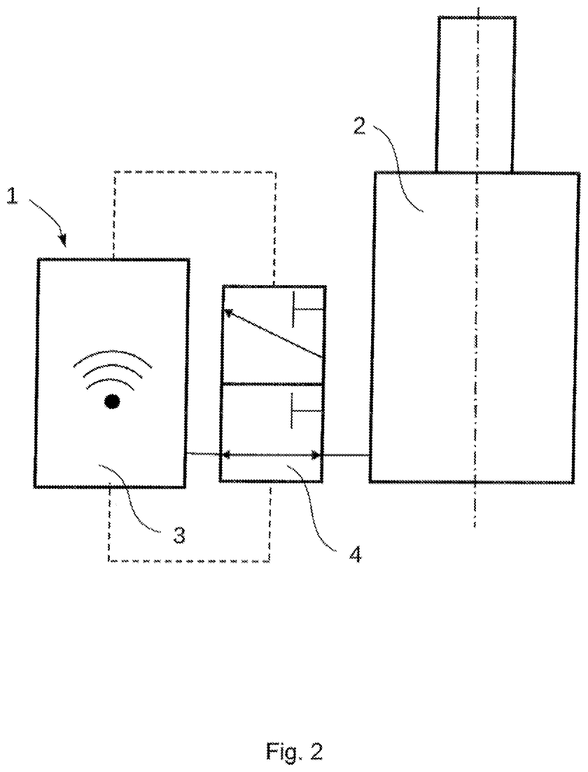

The disclosure is described below with reference to FIGS. 1 and 2 using an exemplary embodiment example. Identical reference numerals refer to identical structural and/or functional features.

FIG. 1 is a side elevation view of the monitoring sensor 1 for measuring, receiving and transmitting a physical variable of a gas pressure spring 2. The monitoring sensor 1 includes a sensor element 3 and a pressure relief opening 4. Here, the pressure relief opening 4 can be switched by remote triggering of the sensor element 3 from an operating state into a safety state in order to evacuate the gas pressure spring 2. The monitoring sensor 1 includes a connection device 5. The connection device 5 can be detached in accordance with the intended use. The connection device 5 connects to a coupling 6 of the gas pressure spring 2.

The sensor element 3 monitors a pressure in the gas pressure spring 2. In addition to the data for the pressure, it optionally determines one or all of the additional variables. They are the temperature, the part number, the part ID, the sensor ID, the position in the tool, the different cycle times, the battery status and the transmission power of the sensor. The sensor element 3 transmits the data wirelessly to a gateway or to a data holder.

In accordance with the operating conditions of the monitoring sensor 1, the mechanical construction of the sensor element 3 is designed to be impact- and vibration-resistant. The sensor element 3 includes a housing 8, made of plastic, and a base plate 9, made of aluminum.

Furthermore, the valve 4 of the monitoring sensor 1 is integrated in the connection section between the connection device 5 and the sensor element 3.

In FIG. 2, a schematic diagram of a gas pressure spring 2 with a monitoring sensor 1 is represented. Here, the monitoring sensor 1 includes the sensor element 3 and the valve 4. With reception of a certain signal or pressure, the monitoring sensor 1 switches the valve 4 from the operating state into the safety state. The adjustment of the valve 4 by the sensor element 3 is triggered by an electromagnetic coil, a micro servo motor or an electromechanical adjustment unit.

Furthermore, FIG. 2 shows that the valve 4 is designed as a 2/2-way safety valve.

The signal for the remote triggering of the sensor element 3 is transmitted wirelessly or via Bluetooth. After reception of the signal, the gas pressure spring 2 is evacuated.

The disclosure is not limited in its embodiment to the above-indicated preferred embodiment examples. Instead, a number of variants are conceivable, which use the represented solution even in embodiments of fundamentally different type.

1.-13. (canceled)

14. A monitoring sensor for measuring, receiving and transmitting a physical variable of a gas pressure spring, comprising a sensor element and a pressure relief opening, wherein the pressure relief opening can be switched from an operating state into a safety state by remotely triggering the sensor element in order to evacuate the gas pressure spring, wherein the monitoring sensor is designed with a connection device, which can be detached in accordance with the intended use, for connecting to a coupling of the gas pressure spring.

15. The monitoring sensor according to claim 14, wherein the sensor element is designed for monitoring a pressure in the gas pressure spring.

16. The monitoring sensor according to claim 14, wherein in addition to data for the pressure, the sensor element optionally determines one or all of the additional variables: the temperature, the part number, the part ID, the sensor ID, the position in the tool, the different cycle times, the battery status and the transmission power of the sensor, and transmits them wirelessly to a gateway or a data holder.

17. The monitoring sensor according to claim 14, wherein with reception of a certain signal or pressure, the monitoring sensor switches the pressure relief opening from the operating state into the safety state.

18. The monitoring sensor according to claim 14, wherein the adjustment of the pressure relief opening by the sensor element is triggered by means of an electromagnetic coil, a micro servo motor or an electromechanical adjustment unit.

19. The monitoring sensor according to claim 14, wherein the sensor comprises a battery or a mechanically chargeable energy storage, which provide the energy for adjusting the pressure relief opening.

20. The monitoring sensor according to claim 14, wherein the pressure relief opening is designed as a valve, in particular a 2/2-way safety valve.

21. The monitoring sensor according to claim 14, wherein the signal for remote triggering of the sensor elements is transmitted wirelessly or via Bluetooth.

22. The monitoring sensor according to claim 14, wherein the sensor element comprises a housing made of plastic and a base plate made of aluminum.

23. The monitoring sensor according to claim 14, wherein the mechanical construction of the sensor element is designed to be impact- and vibration-resistant in accordance with the operating conditions.

24. The monitoring sensor according to claim 14, wherein the sensor element has an operating temperature range from 0° C. to 80° C.

25. The monitoring sensor according to claim 14, wherein the sensor element has a temperature measurement range from 0° C. to 85° C. and a pressure measurement range from 0 bar to 500 bar.

26. The monitoring sensor according to claim 14, wherein the valve is integrated in the connection section between the connection device and the sensor element.
